(19) United States
(12) Patent Application Publication
(10) Pub. No.: US 2008/0243472 A1
(43) Pub. Date: Oct. 2, 2008

(54) Accurate Instant Message Translation in Real Time

(75) Inventors: Ben DeGroot, Los Angeles, CA (US); Giancarlo Tallarico, Los Angeles, CA (US)

Correspondence Address: FOUNTAIN LAW GROUP, INC., 18201 VON KARMAN AVENUE, SUITE 960, IRVINE, CA, 92612, US

(73) Assignee: TELESTIC, LLC, Beverly Hills, CA (US)

(21) Appl. No.: 11/691,472

(22) Filed: Mar. 26, 2007

(51) Int. Cl. G06F 17/28

(52) U.S. Cl. 704/2

(57) ABSTRACT

The invention relates to a system and method for accurately translating instant messages in real time. The system includes a source computing device used to compose an instant message in a first language. Furthermore, the system includes a server connected to the source device through a network, the translation server translates the instant message to form a translated instant message in a second language. In addition, the system includes a destination computing device connected to the translation server through the network and the source computing device to receive the translated instant message, the destination computing device is used to edit the translated instant message to form a revised translation of the instant message. The system further includes an edits server connected to destination computing device through the network to receive and save the revised translation of the instant message for future translation of another instance of the instant message.

### FIELD OF THE INVENTION

The embodiments of the invention generally relate to a system and method to accurately translate instant messages in real time.

### BACKGROUND

Instant messaging has become a widely used tool for communicating in real time over the Internet. An estimated several million of users have been and are using instant messaging applications to communicate or chat with friends and family members. Moreover, several organizations and businesses are integrating instant messaging applications into their repertoire of network tools to facilitate and/or enhance business communications in a cost-effective manner. As such, instant messaging has been used or will be used among users of varying ethnicities, cultures, geographical locations, and languages. Therefore, there exists a need for a system or method to accurately translate instant messages in real time.

### BRIEF DESCRIPTION OF THE DRAWINGS

FIG. 1 shows an exemplary network in which one embodiment of the invention may be implemented.

FIG. 2 illustrates an example of a basic configuration for a computing device on which one embodiment of the invention may be implemented.

FIG. 3A illustrates user screens or windows on computing devices engaging in an exemplary instant message (IM) session in accordance with one embodiment of the invention.

FIG. 3B illustrates an exemplary pop-up window to facilitate the user to edit or revise a translation of the original instant message in accordance with one embodiment of the invention.

FIG. 3C illustrates an exemplary pop-up window to facilitate the user to edit or revise a translation of the responsive instant message in accordance with one embodiment of the invention

FIG. 4 is a flow chart that generally outlines the operation of the system to accurately translate instant messages in accordance with one embodiment of the invention.

FIG. 5 is block diagram illustrating the components and the data flow of a system in accordance with one embodiment of the invention.

FIG. 6 illustrates an exemplary implementation of IMDP in accordance with one embodiment of the invention.

### DETAILED DESCRIPTION

In the following detailed description of the embodiments of the invention, numerous specific details are set forth in order to provide a thorough understanding of the embodiments of the invention. However, it will be obvious to one skilled in the art that the embodiments of the invention may be practiced without these specific details. In other instances well known methods, procedures, components, and circuits have not been described in detail so as not to unnecessarily obscure aspects of the embodiments of the invention.

The invention relates to a method and system for accurately translating instant messages in real time. In the context of this invention, multilingual communication could apply to communication over a network between computer users of varying ethnicities, cultures, geographic locations, and languages. While instant messaging applications are commonly used for providing real-time communication, those skilled in the art will recognize that the invention is applicable to any type of real-time data exchange.

Also, as used herein, “real-time” communication refers to a session established between one or more devices in which information is instantly sent and received. Examples of instant messaging services or networks that facilitate real-time communication would include, but are not limited to, AOL Instant Messenger (AIM), Jabber, ICQ (“I seek you”), Windows Live Messenger, Yahoo! Messenger, GoogleTalk, Gadu-Gadu, Skype, Ebuddy, QQ, .NET Messenger Service, Paltalk, iChat, Qnext, Meetro, Trillian, and Rediff Bol Instant Messenger. In these instant messaging services or networks, sessions are executed according to network protocols designed to enhance and support instant messaging. Such protocols include, but are not limited to, OSCAR (used, for example, in AIM and ICQ), IRC, MSNP (used, for example in MSN Instant Messenger), TOC and TOC2 (used, for example, in AIM), YMSG (used, for example, in Yahoo! Messenger), XMPP (used, for example, in Jabber), Gadu-Gadu, Cspace, Meca Network, PSYC (Protocol for Synchronous Conferencing), SIP/SIMPLE, and Skype. All of these protocols provide data delivery and transport mechanisms for instantly exchanging information between computing devices. The invention is not limited to any one protocol, network implementation, or instant messaging service or network as any architecture by which real-time information exchange can be facilitated is within the scope of the invention.

In the context of a networked environment, general reference will also be made to real-time communication between a “source” device and a “destination” device. The term device includes any type of computing apparatus, such as a PC, laptop, handheld device, or server that is capable of sending and receiving messages over a network according to a standard network protocol. Source computing devices refer to the device that initiates the communication, or that first composes and sends a message, while destination computing devices refer to the device that receives the message. Those skilled in the art will recognize that the operation of the source computing device and destination computing device are interchangeable. Thus, a destination computing device may at some point during a session act as a sender of messages, and a source computing device can at times act as the recipient of messages. For this reason, the systems and methods of the invention may be embodied in traditional source computing devices as well as destination computing devices, regardless of their respective hardware, software or network configurations. Indeed, the systems and methods of the invention may be practiced in a variety of environments that require or desire the performance enhancements provided by the invention. These enhancements are set forth in greater detail in subsequent paragraphs.

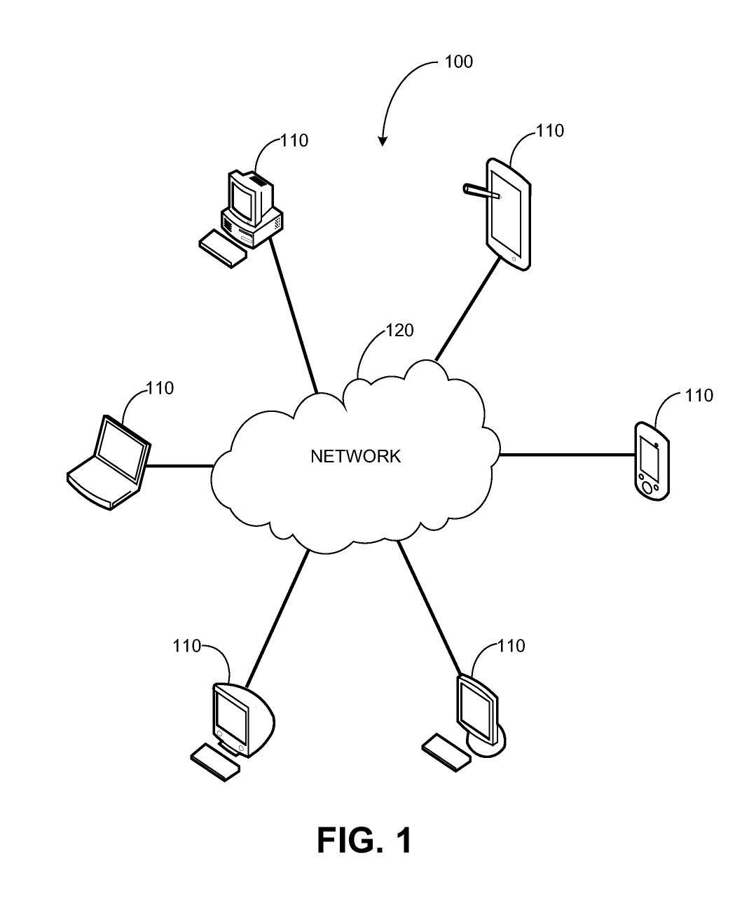

FIG. 1 shows an exemplary network 100 in which one embodiment of the invention may be implemented. The exemplary network 100 includes several computing devices 110 communicating with one another over a network 120, such as the Internet, as represented by a cloud. Network 120 may include many well-known components (such as routers, gateways, hubs, etc.) to allow the computing devices 110 to communicate via wired and/or wireless media.

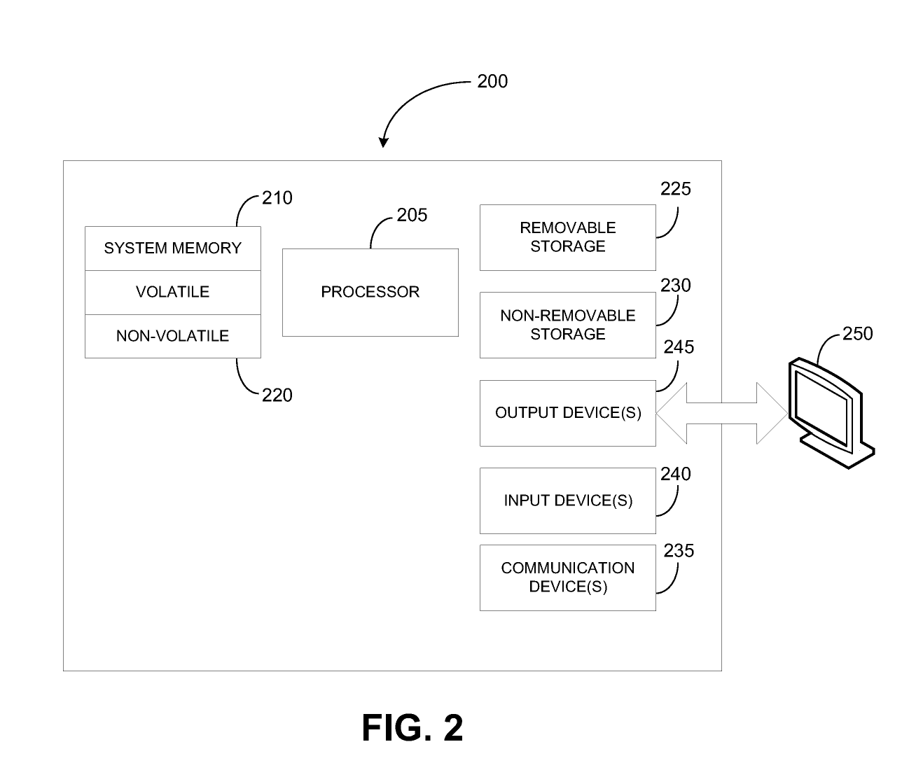

FIG. 2 illustrates an example of a basic configuration for a computing device 200 on which one embodiment of the invention may be implemented. Computing device 200 typically includes at least one processing unit 205 and memory 210. Depending on the exact configuration and type of the computing device 200, the memory 210 may be volatile (such as RAM) 215, non-volatile (such as ROM or flash memory) 220 or some combination of the two. Additionally, computing device 200 may also have additional features/functionality. For example, computing device 200 may also include additional storage (removable 225 and/or non-removable 230) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to stored the desired information and which can be accessed by computing device 200. Any such computer storage media may be part of computing device 200.

Computing device 200 may also contain one or more communication devices 235 that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Computing device 200 may also have one or more input devices 240 such as a keyboard, mouse, pen, voice input device, touch input device, etc. Output devices 240 such as a display 250, speakers, a printer, etc. may also be included. All these devices are well known in the art and need not be discussed at length here.

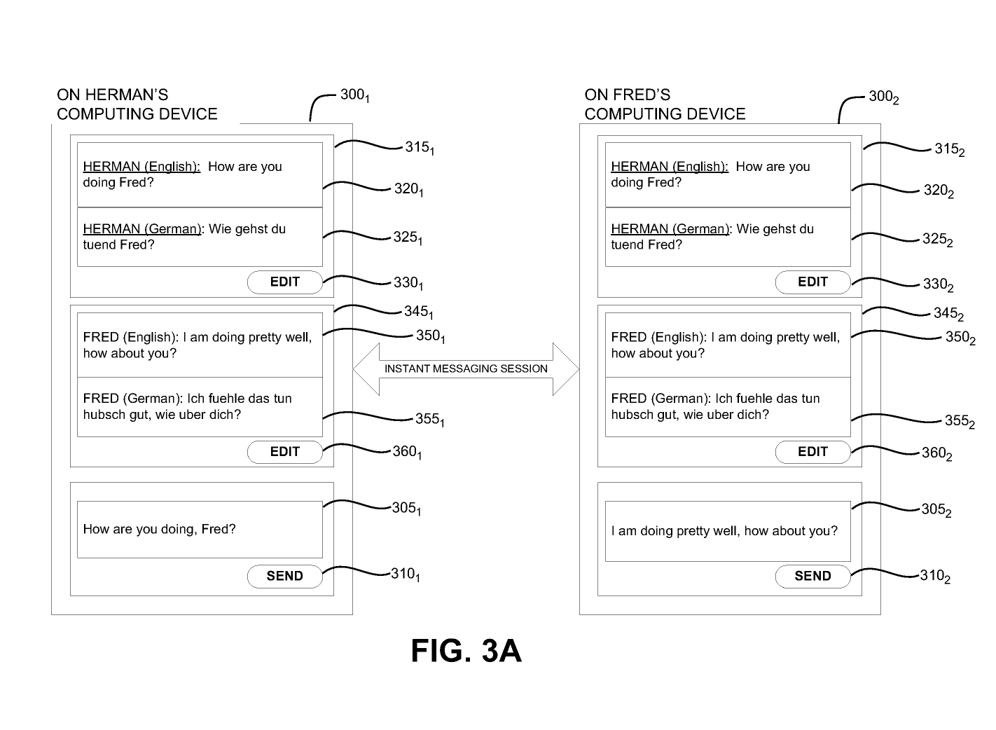

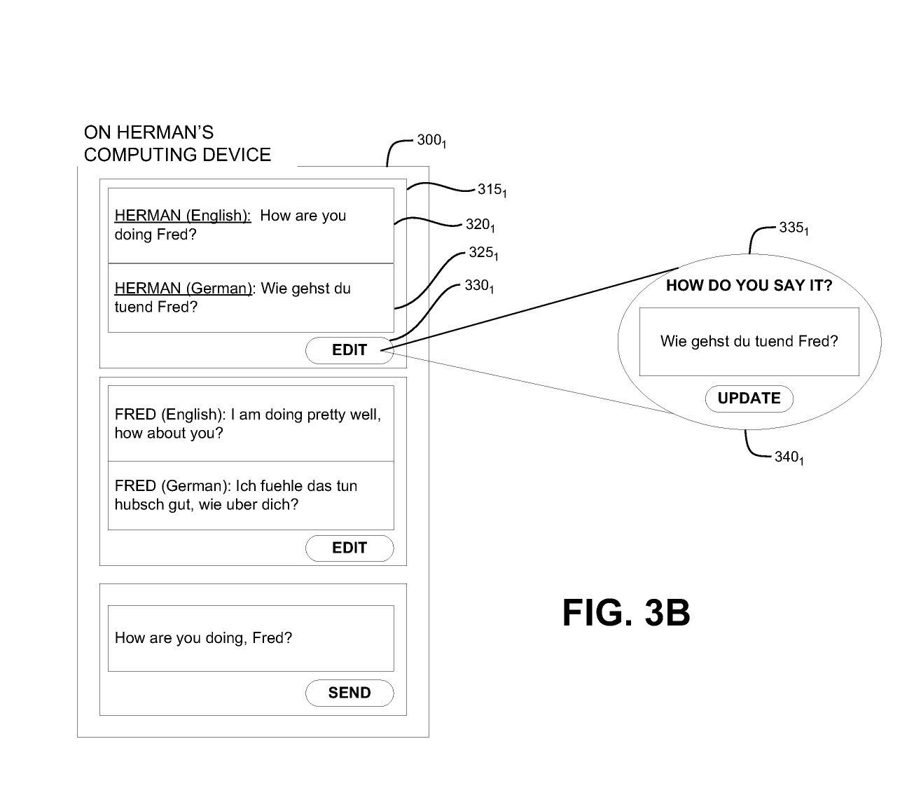

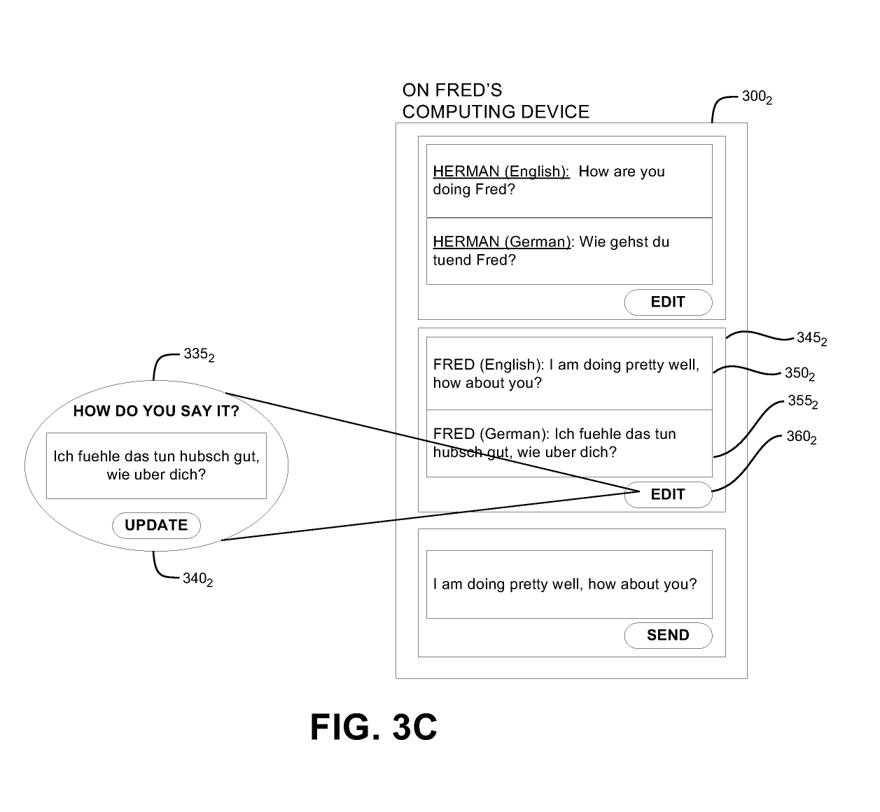

FIG. 3A illustrates user screens or windows on computing devices engaging in an exemplary instant message (IM) session in accordance with one embodiment of the invention. For the purposes of illustrating an example, the languages used in the exemplary IM session of FIG. 3A are English and German. In practice, any languages could be used. As shown FIG. 3A, each user screen or window 300₁ and 300₂ appears on the user's respective computing device. Each user screen 300₁ and 300₂ includes a message composition window (or screen) 305₁ and 305₂ for the user to compose the instant message, and a “SEND” button 310₁ and 310₂ that the user would activate to submit or send the instant message upon completion of composition.

Furthermore, each user window or screen includes a display message window (or screen) 315₁ and 315₂ to display the instant message composed and sent by a first user (e.g., HERMAN as shown in FIG. 3A). The display message window (or screen) 315₁ and 315₂ includes an original display message window (or screen) 320₁ and 320₂ for displaying the message in its original language, and a translated display message window (or screen) 325₁ and 325₂ for displaying the message in another language. As shown in FIG. 3A, the original display message window is used to display the message in English (the source language), and the translated display message window is used to display the message in German (the destination language). Furthermore, there is an “EDIT” button 330₁ and 330₂ situated below the translated display message window. The user would activate this “EDIT” button 330₁ and 330₂ to revise the translated display message.

As shown in FIG. 3B, when the user activates the “EDIT” button 330₁, a pop-up window (or screen) 335₁ would appear. If the user wishes to revise the translated display message, he or she would do so in the pop-up window (or screen), and would push or activate the “UPDATE” button 340₁. By activating the “UPDATE” button 340₁, the user effectively submits his or her revisions or edits of the translation of the display message.

Returning to FIG. 3A, the user window includes a responsive message window (or screen) 345₁ and 345₂ to display the instant message that composed by a second user (FRED as shown in FIG. 3A) in response to the first user's instant message. The response message window (or screen) includes an original response message window (or screen) 350₁ and 350₂ for the displaying the response message in its original language, and a translated response message window (or screen) 355₁ and 355₂ for displaying the response message in another language. As seen in FIG. 3A, the original response message window is used to display the message in English (the source language), and the translated response message window is used to display the response message in German (the destination language). Furthermore, there is an “EDIT” button 360₁ and 360₂ situated below the translated response message window. The user would activate this “EDIT” button 360₁ and 360₂ to revise the translated response message.

As shown in FIG. 3C, when the user activates the “EDIT” button 360₂, a pop-up window (or screen) 335₂ would appear. If the user wishes to revise the translated response message, he or she would do so in the pop-up window (or screen) 335₂, and would push or activate the “UPDATE” button 340₂. By activating the “UPDATE” button 340₂, the user effectively submits his or her revisions or edits of the translation of the response message.

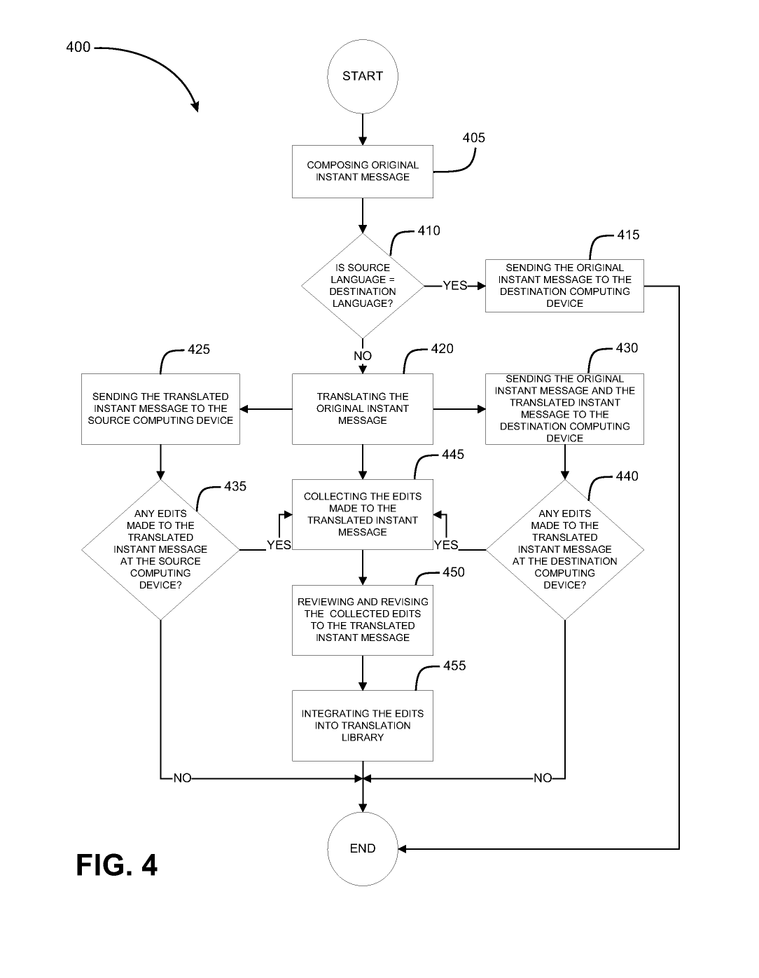

FIG. 4 is a flow chart 400 that generally outlines the operation of the system to accurately translate instant messages in accordance with one embodiment of the invention. In block 405, an instant message is composed using an original source language. In block 410, a determination is made as to whether the source language is the same as the destination language. If yes, the original instant message is sent to the destination computing device (see block 415). If the source language is not the same as the destination language, the original instant message is translated (see block 420). As will be described below in more detail, the translation will be performed by an Artificial Intelligence (AI) based translation server or engine with a neural network that is initially trained with language translation training files, and that is continually refined with user inputs (such as edits or revisions to translated instant messages from actual users or from linguists). Furthermore, the translation would be performed in a language context selected based on statistical weights, such as a profile weight (assigned based on the profile of the user) and/or a convolution weight (assigned based on certain parameters derived from the user inputs such as the frequency of the inputs, or the repetitions or duplicates of the same edits or revisions for the original instant message).

Once the original instant message has been translated, the translated message is sent to the source computing device (see block 425). At the source computing device, the translated instant message is displayed on the device's screen (as shown, for example, in FIGS. 3A and 3B, and described above). Upon reviewing the translated instant message, the user has the opportunity to edit or revise the translation.

In addition, the original instant message and the translated instant message are sent to the destination computing device (see block 430). At the destination computer device, the original instant message and the translated instant message are displayed on the device's screen (as shown, for example, in FIGS. 3A and 3C, and described above). At the destination computing device, the user has opportunity to edit or revise the translation.

If edits or revisions are made to the translated instant message (see blocks 435 and 440), these edits or revisions would be collected (see block 445). As will be discussed below in more detail, the collection of submitted edits or revisions would be performed at the edits server. Furthermore, the collected edits or revisions to the translated message are reviewed and possibly revised. In one embodiment or implementation of the invention, trained linguists would review and revise the collected edits and revisions to the translated instant message (see block 450).

In block 455, the edits or revisions to the translated instant message are integrated into the translation data base. As will be discussed below in more detail, in one embodiment of the invention, the edits or revisions to the translated instant message are collected and saved and periodically sent to the translation server or engine as update(s) to the translation library.

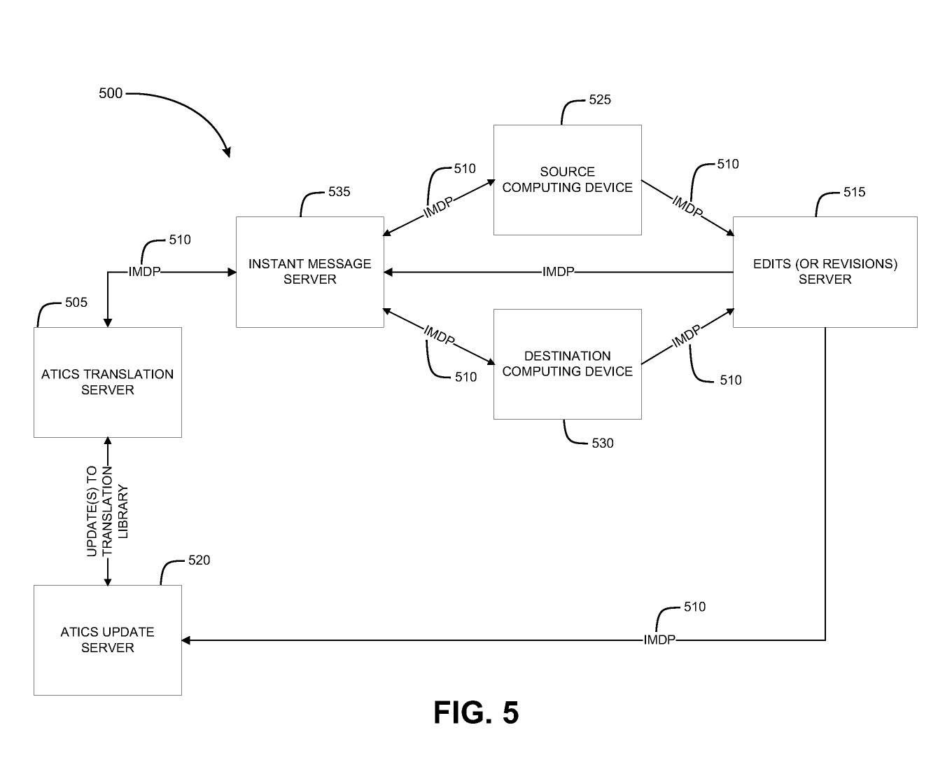

FIG. 5 is block diagram 500 illustrating the components and the data flow of a system in accordance with one embodiment of the invention. In general, this system facilitates the accurate automatic translation of instant messages generated from two separate devices (a source computing device and a destination computing device). Furthermore, once the translated instant message is displayed at the source computing device and the destination computing device, users at these devices could edit and revise the translated instant message. The system would collect and store these edits and revisions (i.e., user inputs or contributions), and would later use these user inputs or contributions (similar to an open source environment). As one example of usage, the system could use the user inputs or contributions to train the AI-based translation engine or server 505. As another example of usage, the system could assigned a weight (referred to as the convolution weight) based on certain parameters derived from the inputs or contributions (such as the frequency of the inputs, or the repetitions or duplicates of the same edits or revisions for the original instant message), and use the assigned weight to select a particular context (such as a formal language context, a slang language context, an age-group-based language context, a sport-centric language context, a language context commonly used at a particular time period—e.g., the 50's, the 60's, the 70's, the 80's, the 90's).

In one embodiment, as shown in FIG. 5, the Instant Message Data Packet (IMDP) 510 is used to facilitate communication among the components in the system. However, as stated above, the invention is not limited to any one instant messaging service or network protocol. More specifically, the invention could be implemented within any instant messaging services or networks that facilitate real-time communication, including, but is not limited to, AOL Instant Messenger (AIM), Jabber, ICQ (“I seek you”), Windows Live Messenger, Yahoo! Messenger, GoogleTalk, Gadu-Gadu, Skype, Ebuddy, QQ, .NET Messenger Service, Paltalk, iChat, Qnext, Meetro, Trillian, and Rediff Bol Instant Messenger. Furthermore, in these instant messaging services or networks, sessions are executed according to network protocols designed to enhance and support instant messaging. Such protocols include, but are not limited to, OSCAR (used, for example, in AIM and ICQ), IRC, MSNP (used, for example in MSN Instant Messenger), TOC and TOC2 (used, for example, in AIM), YMSG (used, for example, in Yahoo! Messenger), XMPP (used, for example, in Jabber), Gadu-Gadu, Cspace, Meca Network, PSYC (Protocol for Synchronous Conferencing), SIP/SIMPLE, and Skype. In general, the system of FIG. 5 would be capable of translating an IMDP to a traditional instant message packet (and vice versa) in accordance with one of the protocols listed above.

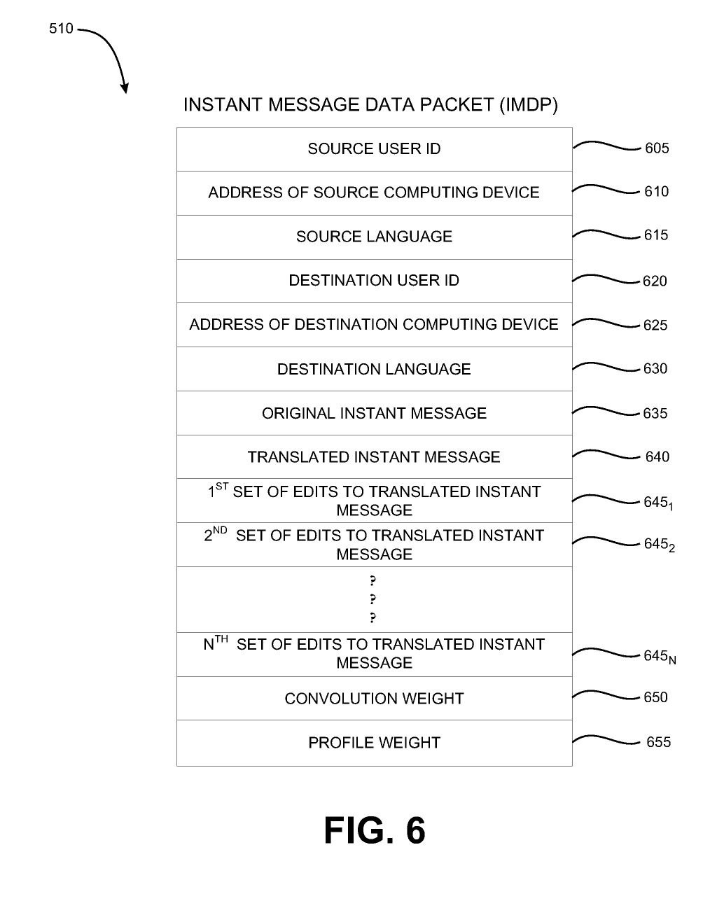

FIG. 6 illustrates an exemplary implementation of IMDP 510 in accordance with one embodiment of the invention. As shown in FIG. 6, the IMDP includes several fields of information. As a general principle of operation, each field of information of the IMDP would be filled in by a component in the system, to the extent possible at particular instances in time, to facilitate communication.

More specifically, the IMDP 510 includes information fields related to the source, including a source user id (or identification) 605, an address of the source computing device 610, and the source language 615. The source user id 605 field contains sufficient information to identify the user at the source computing device. The address of the source computing device 610 would be used to route or send instant messages to the device. The source language field 615 indicates the language that the user at the source computing device could read and would use to compose his or her instant messages.

In addition, the IMDP 510 includes information fields related to the destination, such as a destination user id (or identification) 620, and address of the destination computing device 625, and the destination language 630. The destination user id 620 field contains sufficient information to identify the user at the destination computing device. The address of the destination computing device 625 would be used to route instant messages to the device. The destination language field 630 specifies the language used at the destination computing device.

Furthermore, the IMDP 510 includes fields to contain original instant message 635, the translated instant message 640, and N (where N is a positive integer) slots 645₁, 645₂, . . . , 645_{N} to store edits or revisions made to the translated instant message. The edits or revisions to the translated instant message could be entered by the users at the source computing device or the destination computing device, as well as by one or more linguists assigned to review the edits or revisions made by the users.

In one embodiment, the IMDP also includes a convolution weight 650 field and a profile weight field 655. These fields 650 and 655 are used to select a language context (such as a formal language context, a slang language context, an age-group-based language context, a language context commonly used at a particular time period—e.g., the 50's, the 60's, the 70's, the 80's, the 90's) to perform the translation. More specifically, the convolution weight is assigned based on certain parameters derived from the inputs or contributions (such as the frequency of the inputs, or the repetitions or duplicates of the same edits or revisions for the original instant message). In addition, the profile weight is assigned based on parameters derived from the user profile, such as the user's age and/or geographical location.

Returning to FIG. 5, in one embodiment, after the user at the source computing device 525 composes an original instant message, the source computing device 525 generates an IMDP 510 (containing the source user id, the address of the source computing device, the source language, the destination user id, the address of the destination computing device, and the original instant message) and sends the packet to the instant message server 535. Upon receipt of the packet, the instant message server 535 determines whether the source language is the same as the destination language. If the source language is the same as the destination language, the instant message server 535 simply forwards the packet containing the original instant message to the destination computing device. If the source language is not the same as the destination language, the instant message server 535 forwards the packet containing the original instant message to the ATICS translation server 505 for translation.

In one embodiment, to enable the ATICS translation server 505 to select a proper language context to perform the translation, the instant message server 535 would add or update the profile weight and the convolution weight of the packet that it receives from the source computing device 525 and would send the updated packet to the ATICS translation server 505. In this embodiment, the instant message server would add or update the convolution weight based on parameters relevant to the selection of a proper language context. One example of such a parameter would be the date and time during which the instant message session occurs. In this example, if the date and time indicates that the instant message occurs during working hours of a weekday, a formal (or business) language context should and would likely be selected. Furthermore, the instant message server 535 would typically add or update the profile weight of the packet based on an analysis of the profile of the user at the destination computing device 530.

The ATICS translation server 505 includes an AI-based translation engine that uses a neural network to perform the translation. Before it is operational, the neural network is trained using language training files, which is a collection of deconstructed language phrases represented using numeric values typically used in a machine translation system. Examples of different systems of machine translation that could be used to implement the invention could include, but are not limited to, interlingual machine translation, example-based machine translation, or statistical machine translation. To perform the translation of the original instant message, the ATICS translation server 505 would deconstruct the message into a representative numeric value consistent with the machine translation that is implemented, and use its neural network to perform the translation and to generate a translated instant message. The ATICS translation server 505 would then send the translated instant message (via an IMDP) to the instant message server 535. In one embodiment, the translated instant message could be reviewed and revised by a linguist before it is sent to the instant message server. The IMDP that is sent by the ATICS translation server 505 would be the packet that the server 505 receives plus the translated instant message added by the server 505.

Upon receipt of the IMDP containing the translated instant message and other necessary information, the instant message server 535 would re-route this packet to the source computing device 525 as well as the destination computing device 530. By re-routing the packet, the instant message server 535 is in effect sending the translated instant message to the source computing device 525, and the original instant message as well as the translated instant message to the destination computing device 530.

Upon receipt of the IMDP containing the translated instant message, the source computing device 525 and the destination computing device 535 would display the translated instant message on the respective screen of each device (as shown in FIGS. 3A, 3B, and 3C). The users at each respective device would have an opportunity to edit and revise the translated instant message. After the user at each respective device activates the “UPDATE” button (as shown in FIGS. 3B and 3C) to complete and send the edits or revisions, the edits and revisions would be stored in the edit slots in the IMDP, and the packet would be sent to the edits server 515. In one embodiment, a linguist would review and revise the user edits and revisions made to the translated instant message.

The edits server 515 would forward the edits or revisions to the translated instant message to the ATICS update server 520. The ATICS update server 520 would gather and compile the edits and revisions and would periodically send these edits and revisions to the ATICS translation server 505 as updates to the translation library. In effect, the edits and revisions would be used (as part of the translation library) in subsequent translations of subsequent original instant messages.

Furthermore, in one embodiment, the edits server would add or update the convolution weight based on a review of the edits or revisions made by the user. For example, if the edits server detects that edits or revisions were made to consistently put the instant messages in a formal language context, the server would add a convolution weight or update the existing convolution weight to steer the system toward selecting a formal (or business) language context to perform the translation.

In addition, while the system and method for accurately translating instant messages in real time is disclosed by reference to the various embodiments and examples detailed above, it should be understood that these examples are intended in an illustrative rather than limiting sense, as it is contemplated that modifications will readily occur to those skilled in the art which are intended to fall within the scope of the embodiments of the invention. Rather, the embodiments of the invention should be construed by the claims that follow below.

What is claimed is:

1. A method to translate an instant message comprising:
composing an instant message in a first language;
translating the instant message to form a translated instant message in a second language;
editing the translated instant message to form a revised translation of the instant message; and
saving the revised translation of the instant message for future translation of another instance of the instant message.

2. The method of claim 1, further comprising using the revised translation of the instant message as a final translation of the instant message.

3. The method of claim 1, wherein the step of editing the translated instant message is performed at the source computing device.

4. The method of claim 1, wherein the step of editing the translated instant message is performed at the destination computing device.

5. The method of claim 1, further comprising:
collecting the revised translation of the instant message; and
editing the collected revised translation of the instant message to form a final translation of the instant message.

6. The method of claim 5, further comprising saving the final translation of the instant message for future translation of another instance of the instant message.

7. A system to translate an instant message comprising:
a source computing device used to compose an instant message in a first language;
a translation server connected to the source device through a network, the translation server translates the instant message to form a translated instant message in a second language; and
a destination computing device connected to the translation server through the network and the source computing device to receive the translated instant message, the destination computing device is used to edit the translated instant message to form a revised translation of the instant message; and
an edits server connected to destination computing device through the network to receive and save the revised translation of the instant message for future translation of another instance of the instant message.

8. The system of claim 7, wherein the destination computing device uses the revised translation of the instant message as a final translation of the instant message.

9. The system of claim 7, wherein the source computing device receives the revised translation of the instant message and uses the revised translation of the instant message as a final translation of the instant message.

10. The system of claim 7, wherein the source computing device is used to edit the translated instant message to form a revised translation of the instant message.

11. The system of claim 7, further comprising an update server to gather the edits made to the translated instant messages and to periodically update the translation server with the edits.

12. A method to translate an instant message, comprising:
receiving an instant message in a first language;
translating the instant message to form a translated instant message in a second language;
receiving edits to the translated instant message to form a revised translation of the instant message; and
saving the revised translation of the instant message for future translation of another instance of the instant message.

13. The method of claim 12, further comprising using the revised translation of the instant message as a final translation of the instant message.

14. The method of claim 12, wherein the step of receiving edits to the translated instant message comprises receiving edits from the source computing device.

15. The method of claim 12, wherein the step of receiving edits to the translated instant message comprises receiving edits from the destination computing device.

16. The method of claim 12, further comprising:
collecting a plurality of revised translations of the instant message; and
compiling the collected revised translations of the instant message for computerized processing to form a final translation of the instant message.

17. The method of claim 16, further comprising saving the final translation of the instant message for future translation of another instance of the instant message.

18. The method of claim 16, wherein the computerized processing is performed by an artificial intelligence system.
